(19) United States
(12) Patent Application Publication
(10) Pub. No.: US 2007/0299982 A1
(43) Pub. Date: Dec. 27, 2007

(54) Device Independent Data Streaming

(76) Inventors: Christopher Armstrong, Co. Westmeath (IE); Eamonn Roarke, Co. Galway (IE)

Correspondence Address: PROCOPIO, CORY, HARGREAVES & SAVITCH LLP, 530 B STREET, SUITE 2100, SAN DIEGO, CA, 92101, US

(21) Appl. No.: 11/570,274

(22) PCT Filed: Jun. 8, 2005
(86) PCT No.: PCT/IE05/00065

§ 371 Date: Jul. 16, 2007

(30) Foreign Application Priority Data
Jun. 9, 2004 (IE) S2004/0394

(51) Int. Cl. G06F 15/16

(52) U.S. Cl. 709/231

(57) ABSTRACT

A system and method are provided for controlling data distribution in a network (108, 109). The network has data-generating and data-receiving devices (101, 102, 103, 105, 106, 111, 112, 113, 116, 117, 118, 206). The system includes memory means (209), processing means (203), networking means (212), at least one input controller (404) and at least one output controller (404). The memory means (209) stores instructions (402) which configure said processing means (208) to identify data-generating devices (101, 102, 206, 111, 112 113) and data-receiving devices (103, 105, 106, 107, 116, 117, 118) in said network. The identified devices (102, 103, 105, 106, 111, 112, 113, 116, 117, 118, 206) are initialised across said network by way of said input controller (404) and one output controller (404). Input data (405, 406) is controlled by said input controller (404). Output data (407, 408) is controlled by said output controller (404). Control is performed selectively according to user input (409).

### FIELD OF THE INVENTION

The present invention Mates to distributing digital data between a plurality of data-processing devices. More particulaly, the present invention relates to a system for co-ordinating the acquisition and distribution of digitised audio, visual data and video content between a plurality of devices.

### BACKGROUND TO THE INVENTION

Improvements in both networking technology and data processing capacity have permitted the rapid development of user-friendly data distribution systems, such as the internet, implemented by way of either wired or wireless networks, or even both types of networks concurrently.

Within this context, many systems are known with which to broadcast digitised audio and visual data, often referred to as multimedia content, from a network node to many remote network nodes. Recent improvements in multimedia data formatting and processing have resulted in such data being distributed as packets, which may be immediately processed in packet form by said remote nodes instead of requiring the complete transmission thereof as a data file, wherein such distributed data is said to be streamed over said network.

A particular field of application for this technology may be found in presentation systems, which make use of digitised audio-visual data to enhance the communication of information, such as concepts and reports, to an audience. Remote or local audio-visual data is processed by a data processing system such as a computer and output via a wired network, a wireless network or a direct connection to audience presentation means such as projectors, data processing devices such as computer terminals or mobile phones, or even individual displays. Such data is preferably streamed in order to output the presentation to the audience in real time, or in as near real-time as the network latency allows.

US 2003/1218597 discloses one such presentation system, wherein presentation data is distributed by way of wireless communication between devices in an ad-hoc network in a room or local area The document describes a system that allows a presenter to control the information displayed on a projector or through the speakers, as well as devices in a conference room such as heating, curtains, lights, and smoke machines over any wireless network. An attendee can view the presentation on his/her computer which can be the same or different to that on the presenters computer and the presenter or attendee terminal can be anything from a mainframe to a mobile phone. All equipment in the system connects to an ad-hoc network, wherein the network is formed automatically by the devices near each other connecting to each other. In a particular embodiment, ad-hoc networks such as Bluetooth or WI-FI (Local Area Network 812.11) log any device onto the network, thus allowing then to be controlled. The system also discloses a wireless enabled audiovisual apparatus communicating with a wireless enabled computer, comprising a projector and a loudspeaker system, which sends information wirelessly from the presenter's computer to one or many attendees' computers and display devices.

US 2003/0224807 discloses a standalone presentation system embodied as a Wireless Interactive Presentation System (WIPS), which is a projector controller. A WIPS is situated beside a projector, and is connected to the projector using a video interface or USB interface. Each WIPS can be connected to one or more remote PCs wirelessly, and can output the display data of programs running on any one of those PCs to the projector. The operator can use an infrared remote control to switch the WIPS between the various PCs. The WIPS has an on-board user interface that can be used by the operator to control both WIPS and presentations. More than one WIPS can run in a network at a time, but they are independent and do not communicate in any way.

WO 2004/025952 discloses another standalone presentation system. In he system described in this prior art document, a display apparatus is a projector to which presentation files may be sent. The projector then reads the presentation itself and displays it. The display apparatus is composed of two components, a reproduction unit th can read process the presentation files into video out, and a display unit that can show the video output produced by the reproduction unit The display apparatus has a wireless interface that allows it to be connected to a wireless network and can also be connected to a wired network. In a particular embodiment, a Personal Digital Assistant can control the images being displayed on such a projector and may send a network address (such as an Internet-formatted Uniform Resource Location) of a presentation anywhere in the network (from the PDA itself to the internet) to the projector, and ask the projector to fetch and run that presentation The projector can run and present more than one presentation at a time to more than one display, or display multiple presentations on the display at a time; one on top of each other or side by side.

An important problem in presentation systems as described above is that most such prior art systems fail to provide a single, cost-effective and user-friendly solution to a presenter having to broadcast one or a plurality of presentations including a plurality of source material and/or in different formats, to multiple devices across multiple networks simultaneously. For example, in the case of a presentation concurrently requiring visual data input from both remote storage and another remote location in real-time, as well as audio data provided by the presenter and simultaneous, remote foreign language translators, none of the above systems would allow said presenter to deliver the intended multi-format, multi-lingual presentation too multi-national audience including local and remote attendees equipped with different receiving wired and wireless devices, without expensive technical assistance and some degree of advance planning and project management.

### OBJECT OF THE INVENTION

In order to overcome the problems of the prior art, it would be advantageous to provide a system and method configured for controlling the distribution of audiovisual data over any network, wherein such data is selectively generated by a plurality of differing network-connected source devices and said data is selectively distributed to a plurality of network-connected target devices.

### SUMMARY OF THE INVENTION

According to one aspect of the present invention, a system is provided for controlling data distribution in a network, said network having at least one data-generating device and at least one data-receiving device, said system comprising memory means, processing means, networking means, at least one input controller and at least one output controller, said memory means storing instructions which configure said processing means to identify said at least one data-generating device and said at least one data-receiving device in said network; initialise said identified devices across said network by way of said at least one input controller and said at least one output controller respectively; control data input by said initialised data generating device by way of said at least one input controller and control data output to said initialised data receiving device by way of said at least one output controller, wherein said control is performed selectively according to user input.

According to another aspect of the present invention, a method for controlling data distribution in a network having at least one data-generating device and at least one data-receiving device, said method comprising the steps of identifying said at least one data-generating device and said at least one data-receiving device in said network; initialising said identified devices across said network by way of said at least one input controller and said at least one output controller respectively; controlling data input by said initialised data generating device by way of said at least one input controller and controlling data output to said initialised data receiving device by way of said at least one output controller, wherein said control is performed selectively according to user input.

According to yet another aspect of the present invention, a data carrying medium is provided which contains a set of instructions for controlling data distribution in a network having at least one data-generating device and at least one data-receiving device, whereby when loaded into a data processing system configured with data caring reading means, said instructions configure a processor to identify said at least one data-generating device and said at least one data-receiving device in said network; initialise said identified devices across said network by way of said at least one input controller and said at least one output controller resetively; control data input by said initialised data generating device by way of said at least one input controller and control data output to said initialised data receiving device by way of said at least one output controller, wherein said control is performed selectively according to user input.

The advantage of the present invention over existing prior art is that the system can handle source devices which can be an arbitrary number of source devices (video cameras etc) and target devices (projectors etc) to be controlled and administered by a single system. Presentation Sessions can be set up on demand towards any device, no matter where they are located which can be set up between any source device and one to many target devices simultaneously or using archived material to one or many target devices simultaneously. The system of the present invention is completely distributed, the system can be deployed locally, or the various components can be deployed geographically anywhere. The user can control all devices (input and output) and control the connection setup between them. The user has fill control of where the material being used in his or her presentation is taken from and is sent to. The user can select on the fly which material to use and where to show (or send) that material. Additionally the present invention allows for broadcast of media streams to remote projectors using an RF (Radio Frequency) Media Stream Relay Component.

Preferably, the network includes a plurality of data-generating devices and at least one data-receiving device, each of said data-generating devices having a respective input host controller and said data-receiving device having an output host controller.

Alternatively, the network includes at least one data-generating device and a plurality of data-receiving device, each having a respective host controller, said data-generating device having an input host controller and each of said data-receiving devices having a respective output host controller.

Alternatively still, the network includes a plurality of data-generating devices and a plurality of data-receiving devices, each of said data-generating devices having a respective input host controller and each of said data-receiving devices having a respective output host controller.

Desirably, input host controllers and output host controllers control direct network connections between respective data-generating devices and data-receiving devices.

User input advantageously defines a data distribution session, comprising one or a plurality of said direct network connections. Alternatively, user input defines a plurality of data distribution session, comprising one or a plurality of respective direct network connections.

Preferably, network is a composite network including wired and wirelessly-connected devices. Input data and output data may be distributed within said network by way of radio broadcasts, or input data and output data is distributed within said network by way of infra-red transmissions.

Ideally there is also provided a computer program comprising program instructions for causing a computer program to carry out the above method which may be embodied on a record medium, carrier signal or read-only memory.

### BRIEF DESCRIPTION OF THE DRAWINGS

FIG. 1 shows a preferred embodiment of the present invention in a networked environment, including a system for controlling data, data-generating devices and data-receiving devices, wherein said system includes a terminal;

FIG. 2 describes typical components of the terminal shown in FIG. 1, including a memory;

FIG. 3 details the operational steps according to which the terminal of FIGS. 1 and 2 operates, including a step of loading instructions;

FIG. 4 illustrates the contents of the memory shown in FIG. 2, further to the instructions loading step shown in FIG. 3, when the t a of FIGS. I and 2 processes said instructions at runtime;

FIG. 5 firer details the network device acquisition shown in FIG. 3;

FIG. 6 further details the session parameters inputting step shown in FIG. 3;

FIG. 7 further details the data distribution controlling step shown in FIG. 3;

FIG. 8 shows an example of visual and audio data respectively input by multiple data-generating devices being broadcast to a plurality of local and remote, wired and wirelessly-connected data-receiving devices in the environment described in FIG. 1.

### DETAILED DESCRIPTION OF THE DRAWINGS

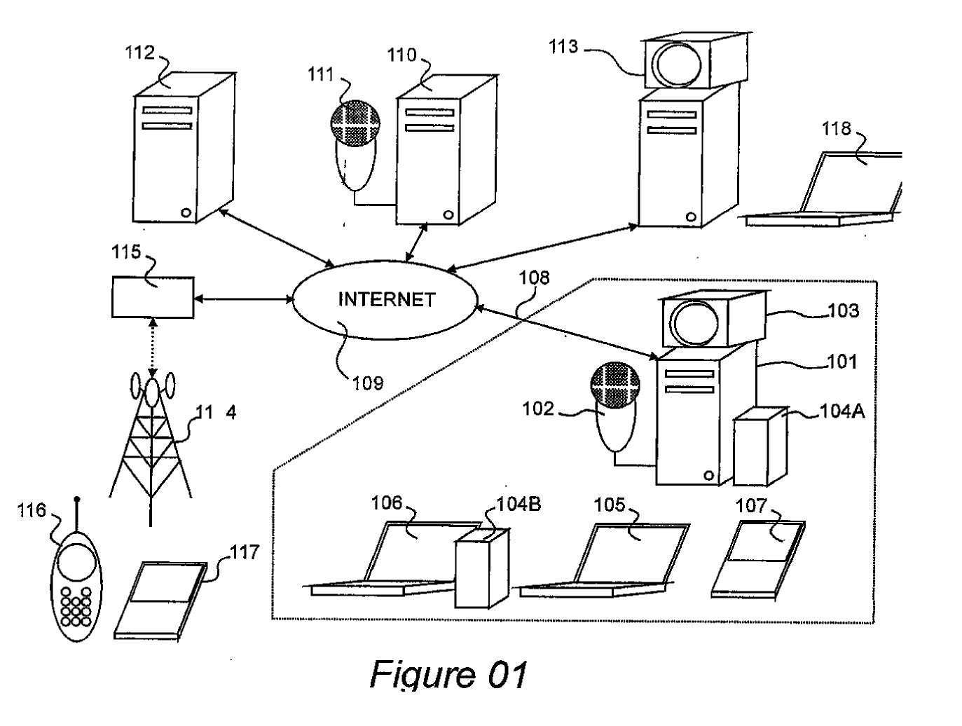

A networked environment is shown in FIG. 1, which includes a system for controlling data and a plurality of network-connected data-generating devices and data receiving devices, wherein some of said network connections are wired and some are wireless and said system includes a terminal 101. In the example, terminal 101 is located at a presentation venue, at which a user shall provide a presentation including an advertisement, real-time store footage, slides and real-time sales data to local and remote attendees in a plurality of languages.

In order to provide the required audio-visual data to local attendees, terminal 101 is configured with audio data inputting means 102, for example a microphone, visual data projecting means 103 and, in a preferred embodiment of the present invention, wireless audio-visual data broadcasting means 104A. At said presentation venue still, some attendees are equipped with a variety of wireless data receiving devices, examples of which include personal portable computer 105 configured with wireless local area networking means (for instance conforming to the IEEE 802.11 protocol) as well as a personal portable computer 106 configured with wireless audiovisual data receiving means 104B, and a mobile communication device 107 configured with alternative networking means (for instance conforming to the Bluetooth protocol).

In order to provide the required audio-visual data to remote attendees, terminal 101 is further configured with a wide area network (WAN) connection 108, such as a connection to the Internet 109. A portion of the required audio-visual data may be remotely stored and/or provided, which will be communicated to both local and remote attendees in accordance with the present invention. An example of remote audio data is the simultaneous translation of the user's speech input with microphone 102 by a remote translator equipped with a terminal 110 configured with audio data inputting means 111, which is also connected to the Internet 109. An example of remote video data is the required advertisement, which is stored as digital data at a remote famestore 112, also connected to the Internet 109. Another example of remote video data is the required, real-time store footage which is provided by a webcam located at said store and interfaced with a terminal 113 also connected to the Internet 109.

During the presentation, said local and remote audio-visual data is relayed respectively to or from local and remote mobile devices. Said data is relayed to local devices 105, 106, 107 via wireless LAN or Bluetooth networks as well as the output of projector 103 and is relayed to remote devices as a digital signal by the geographically-closest communication link relay 114 of a plurality thereof. Said plurality of communication link relays allows said digital signal to be routed between any data source and its intended recipient or from its remote emitter by means of a remote gateway 115. Gateway 115 is for instance a communication network switch coupling digital signal traffic between wireless telecommunication networks, such as the network within which wireless data transmission takes place, and a wide area network (WAN), an example of which is the Internet 109. Said gateway 115 further provides protocol conversion if required, for instance if the mobile device 116 of a first remote attendee uses Wireless Application Protocol (WAP), mobile device 117 of a second remote attendee and personal portable computer 118 of a third remote attendee use HyperText Markup Language 13.

Within the composite network described in FIG. 1, there is therefore provided the scope for any which one of the local and remote data-generating devices 101 to 104 and 110 to 113 to distribute audiovisual data to any which one of the data receiving devices 105 to 107 and 116 to 118 of local and remote attendees respectively.

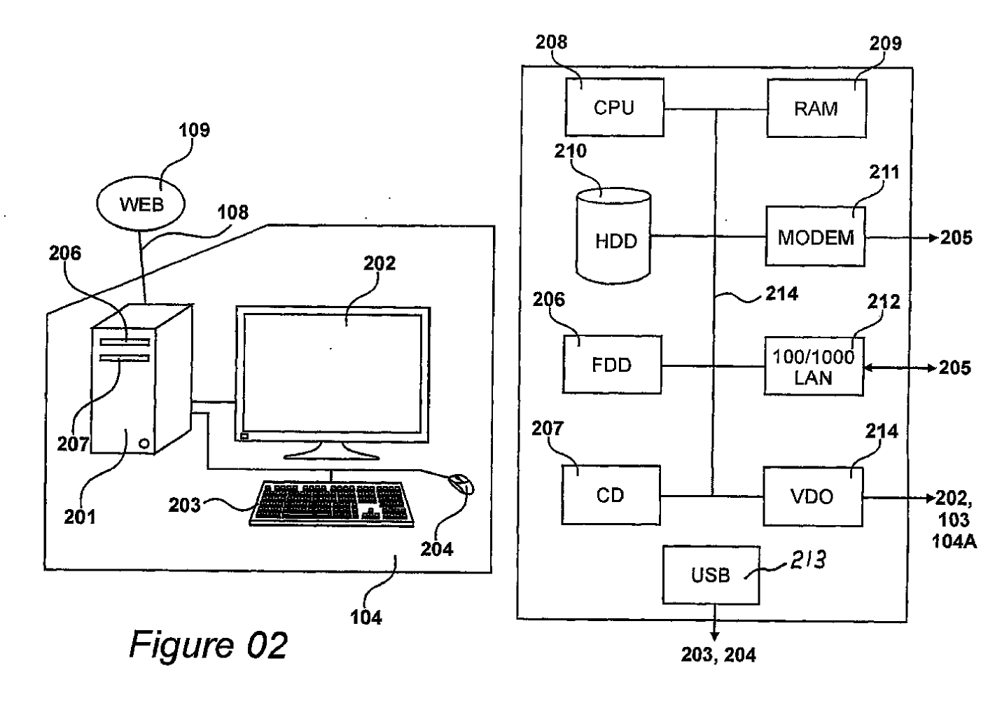

An example of the terminal 101 for controlling data distribution shown in FIG. 1 is provided in FIG. 2. Terminal 101 is a computer terminal configured with a data processing unit 201, data outputting means such as video display unit (VD U) 202, data inputting means such as a keyboard 203 and a pointing device (mouse) 204 and data inputting/outputting means such as a network connection 108, magnetic data-carrying medium reader/writer 206 and optical data-carrying medium reader/writer 207. Within data processing unit 201, a central processing unit (CPU) 208, such as an Intel Pentium 4 manicured by the Intel Corporation, provides task co-ordination and data processing functionality. Instructions and data for the CPU 208 are stored in main memory 209 and a hard disk storage unit 210 facilitates non-volatile storage of data and data processing instructions. A modem 211 provides a wired connection to the Internet 211 or said wired connection to the Internet may be performed through a Local Area Network N network card 212, particularly if said connection is of the type known as broadband. In a preferred embodiment of the present invention, said network card 212 is further configured with wireless data distributing means, for instance to establish a wireless network connection of the type known as Wi-Fi (EEE 802.11 protocol) with other proximate devices having similar networking means.

A universal serial bus (USB) input/output interface 213 facilitates connection to the keyboard and pointing device 203, 204. All of the above devices are connected to a data input/output bus 214, to which said magnetic data-carrying medium reader/writer 206 and optical data-carrying medium reader/writer 207 are also connected A video adapter 215 receives CPU instructions over said bus 214 for outputting processed data to VDU 202 and/or to further output data display means, such as a USB-connected or PC-signal-connected LCD projector 103 and wireless data radio transmitter 104A.

In the embodiment, data processing unit 201 is of the type generally known as a compatible Personal Computer (‘PC’), but may equally be any device configured with data inputting, data processing, data outputting and networking means providing at least the functionality described above. Any such device may include, but is not limited to, PowerMac® or iMac® computers manufactured by the Apple® Corporation of Cupertino, Calif., USA; a Portable Digital Assistant (DA) such as a Palm m505® manufactured by PalmOne® Inc. of Milpitas, Calif., USA; a Portable Digital Computer (PDC) such as an IPAQ® manufactured by the Hewlett-Packard® Company of Palo Alto, Calif., USA; or even a mobile phone such as a Nokia 9500 manufactured by the Nokia® Group in Finland, all of which are generally configured with processing means, output data display means, memory means, input means and wired or wireless network connectivity.

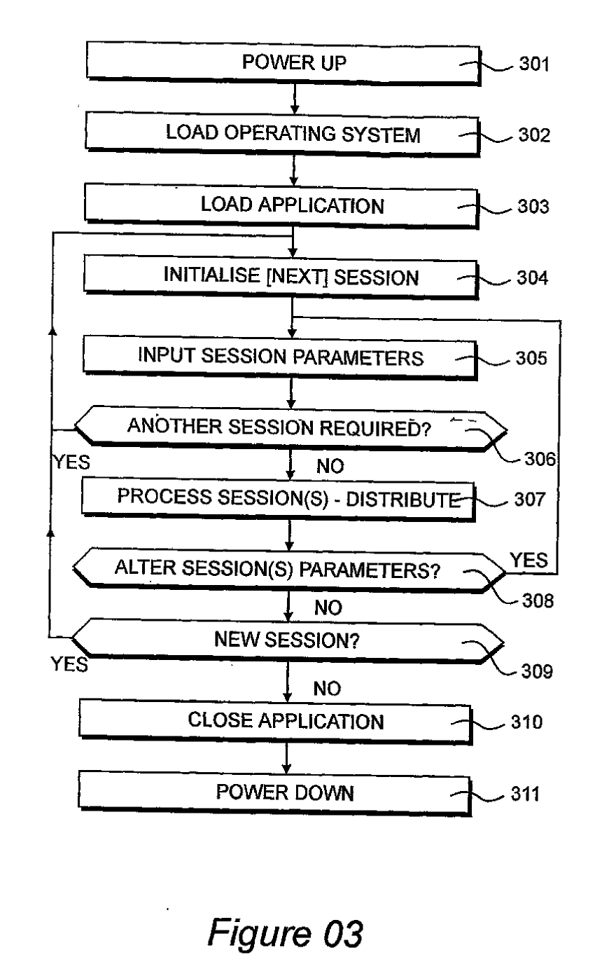

Processing steps are described in FIG. 3 according to which terminal 101 operates. Terminal 101 is first switched on at step 301. At step 302, the operating system is loaded which provides said terminal 101 with basic functionality, such as initialisation of data input and/or output devices, data file browsing, keyboard and/or mouse input processing, video data outputting, network connectivity and network data processing. At step 303, an application is loaded into memory 209, which is a set of instruction for configuring CPU 208 to process data according to rules described hereafter.

At the next step 304, the application initialises a presentation session, wherein said session will, after the parameterisation thereof, define a selectively-controlled distribution of audio-visual data between data-generating devices and data-generating receiving devices within the network shown in FIG. 1, according to the present invention. At step 305 therefore, session parameters are input as the control parameters of said distribution, whereby upon completing said inputting step, a first question is asked at step 306, as to whether the user requires to define a further session, for instance if during the same presentation event, alternative audio-visual data should be sent to local or remote attendees different from the audience of the audio-visual data distributed according to the first session.

If the question of step 306 is answered positively, control returns to step 304, whereby the next session is initialised and so on and so forth. Alternatively, the question of step 306 is answered negatively and terminal 101 processes the one or many sessions defined according to steps 304 to 306 at the next step 307. A second question is asked at step 308 as to whether the user-presenter has altered session parameters whilst the sessions are being processed. If the question of step 308 is answered positively, control proceeds to step 305, whereby alternative parameters may be input to override the initial input parameters. Alternatively, the question of step 308 is answered negatively, the one or many sessions are processed to the conclusion, i.e. all of the selected audio-visual data has been distributed and the same user, or the next user-presenter may choose to define one or many new sessions, e.g. for the next presentation to the same or a different audience, with answering the question of step 309 positively such that control proceeds back to step 304. Alternatively, the question of step 309 is answered negatively and said user may choose to terminate the application at step 31 0 and subsequently switch the terminal off at the final step 311.

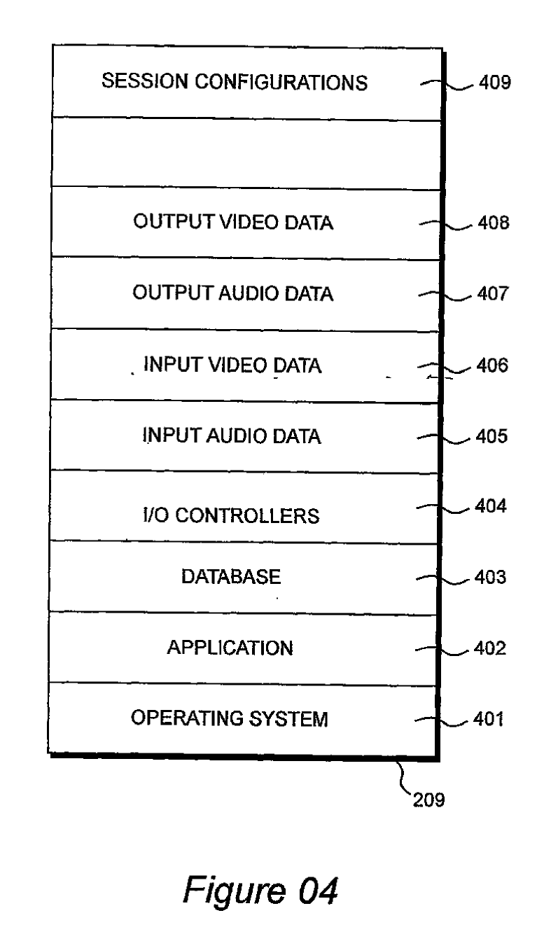

The contents of the memory 209 of terminal 101 are illustrated in FIG. 4 subsequently to the loading of instructions at step 303, whilst a session is being processed according to step 307.

An operating system is shown at 401 which, in the embodiment, is Windows™ XP™

Professional™ manufactured and licensed by the Microsoft Corporation of Redmond, Calif., USA. It will be understood by those skilled in the art that said OS is not limitative and, having regard to the alternative terminals described there above, may be OSX™ provided by Apple™, PalmOS™ provided by PalmOne™, LINUX which is freely distributed or Windows™ CENT 3.0 provided by Microsoft. An application is shown at 402 which integrates the set of processor instructions according to which audio-visual data is distributed as described herein. A database is shown at 403, which references sessions, parameters thereof, data-receiving devices, data-generating devices, audio data and visual data.

Input host controllers and output host controllers are shown at 404 under the form of an Application Programmers Interface (API), the function of which is to initialise local and remote data generating and receiving devices and translate user input processed by application 402 into logic commands which any which one of said devices may perform.

Audio data provided by local or remote data-generating devices, such as microphones 102 and 111 is shown at 405 and video data similarly provided by local or remote data-generating devices, such as framestore 112 and webeam 113 is shown at 406. Audio data broadcast to local or remote data-receiving and video data similarly broadcast to local or remote data-receiving devices, such as projector 103, local attendees terminals 105 to 107 and remote attendees terminals 116 to 118 are respectively shown at 407 and 408. Session configuration data is shown at 409 which corresponds to the session parameters input either at step 305 or in response to questions 308 or 309.

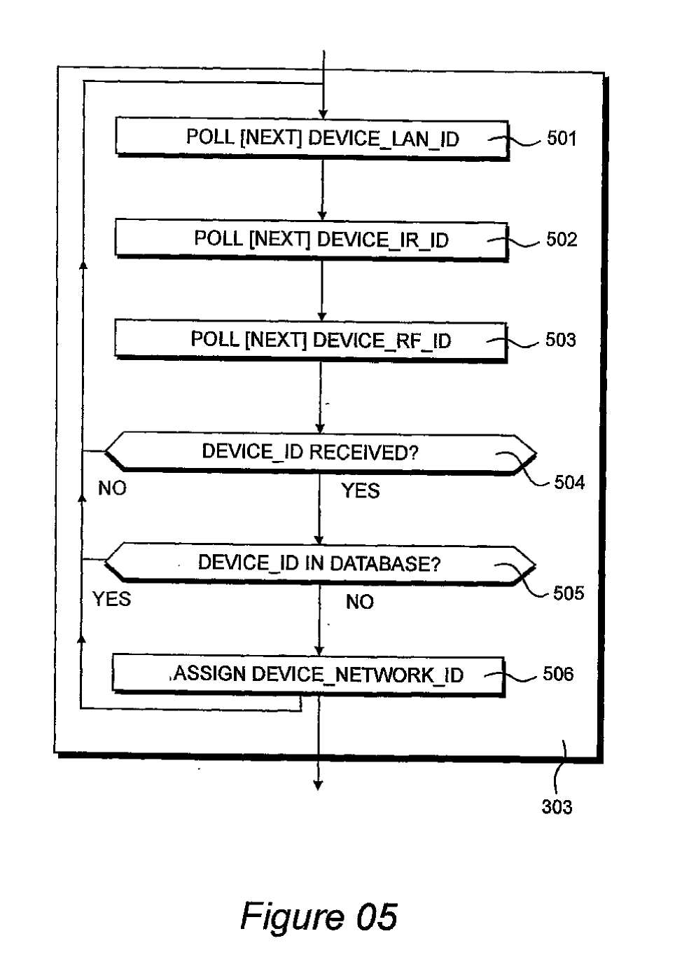

The step 303 of loading the application 402, within which said application identifies all local and remote network-connected devices, is flintier detailed in FIG. 5. Upon initialising the application, a network daemon is started, which is preferably processed while ever application 402 distributes data according to steps 304 to 309 and the function of which is to dynamically identify local and/or remote data-generating and data-receiving devices in order to individually identify audio-visual data sources and targets for the API 404 to initialise and the application 402 to control.

At a first step 501, the application daemon polls the wired area networks, which include local and wide area networks, for device identifiers which may preferably be provided by their respective user-attendees with a log-in at terminal 101. At the next step 502, the application daemon polls the spectrum network, which includes proximate devices configured for infrared data distribution, for device identifiers which may again preferably be provided by their respective user-attendees with a log-in at terminal 101. At the next step 503, the application daemon polls the radio networks (Wi-Fi and Bluetooth), which includes proximate devices configured for radio-frequency based data distribution, for device identifiers which may again preferably be provided by their respective user-attendees with a log-in at terminal 101.

A first question is asked at step 504, as to whether a device identifier has been received subsequently to any of the polling steps 501 to 503. If the question of step 504 is answered negatively, control proceeds back to step 501, whereby polling according to said step 501 and subsequent steps 502, 503 resumes. Alternatively, the question of step 504 is answered positively, whereby a second question is asked at step 505, as to whether the received identifier already has a corresponding entry in the database 403. If the question of step 505 is answered negatively, the application 402 declares said device identifier entry in said database 403 at 506 and instructs the daemon to resume polling for devices at step 501. Alternatively, the question of step 505 is answered positively whereby control again proceeds back to polling step 501.

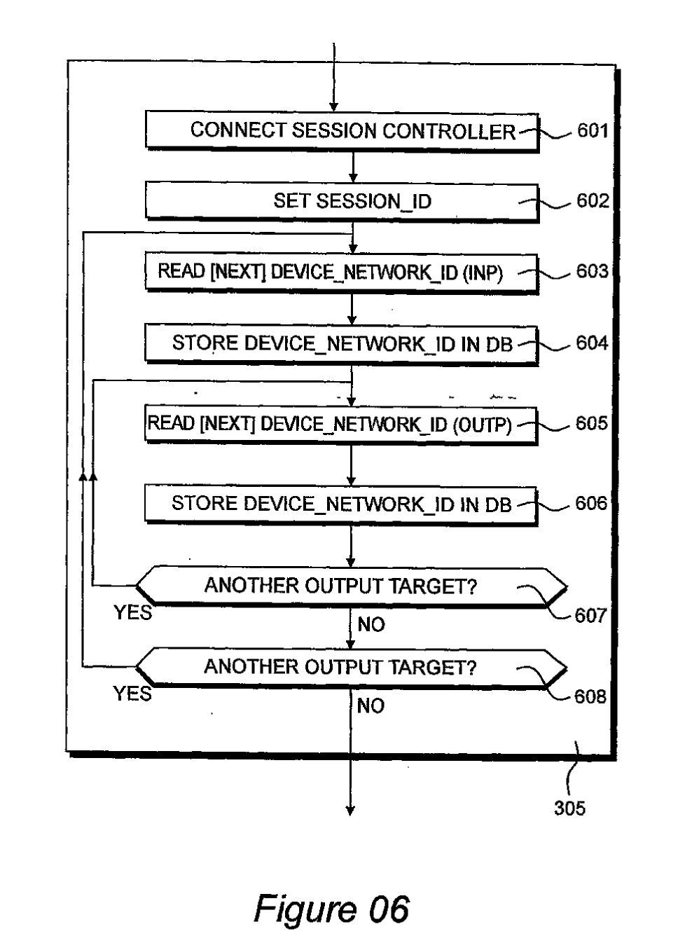

The step 305 of inputting session parameters after identifying and registering network-connected devices is further detailed in FIG. 6. At step 601, the user connects a session controller to terminal 101 over any of the aforementioned wired or wireless networks, wherein said session controller is either said terminal 101 or, in an alternative embodiment of the present invention, a local or remote data processing terminal, such as personal portable computer 105, personal digital assistant 107 or even mobile device 116. At step 602, application 402 declares a session identifier with which the session controller connected at the previous step 601 is associated.

Session parameters are subsequently read from the user input data provided at said session controller, whereby the selection of a first data-generating network-connected device is read at step 603 and subsequently stored in database 402 at the next step 604 in relation to said session identifier of said step 602. At the next step 605, the selection of a first data-receiving network-connected device is read and subsequently stored in database 402 at the next step 606 in relation to said session identifier of said step 602 and selected data-generating device of said steps 603, 604.

A question is asked at step 607, as to whether the user-presenter has selected another data-receiving network-connected device to which to output data generated by the device selected at steps 603, 604. If the question of step 607 is answered positively, control proceeds back to step 605, whereby the identifier of said additional selected data-receiving network-connected device may be read and stored according to steps 605, 606 and so on and so forth. Alternatively, the question of step 607 is answered negatively and a second question is asked at step 608, as to whether the user-presenter has selected another data-generating network-connected device from which to output data If the question of step 608 is answered positively, control proceeds back to step 603, whereby the identifier of said additional selected data-generating network-connected device may be read and stored according to steps 603, 604 and respective data-receiving network-connected devices associated therewith and so on and so forth, Eventually, the session is filly parameterised to deliver the intended multi-format, multi-lingual presentation to a multi-national audience including local and remote attendees equipped with different receiving wired and wireless devices.

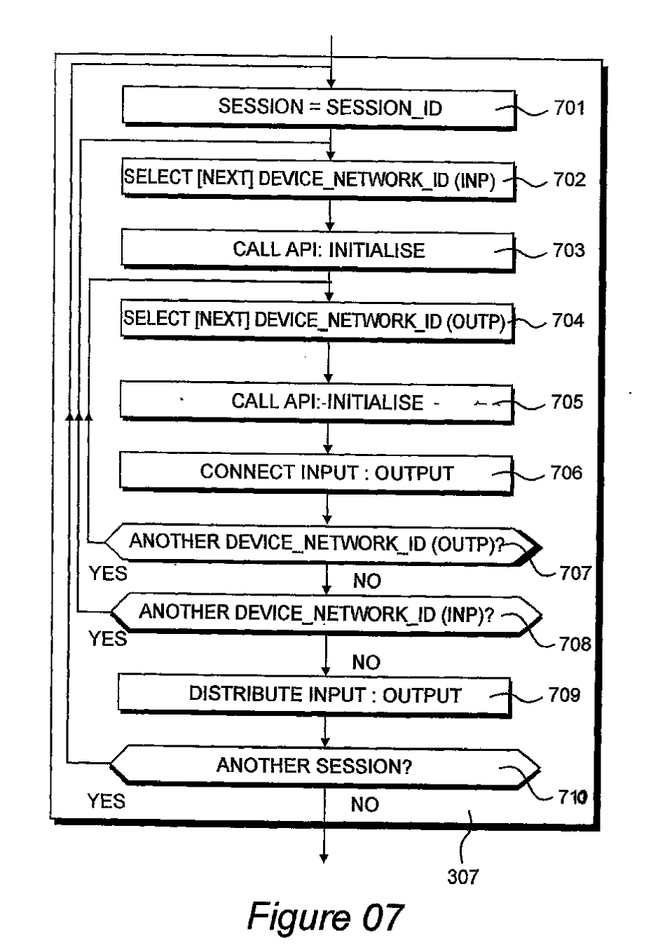

The step 307 of processing one or more sessions according to the parameters shown in FIG. 6 is further detailed in FIG. 7. At step 701, the application 402 declares the session to be processed according to the session identifier stored in database 403.

At the next step 702, application 402 selects the next data-generating network-connected device identifier stored in database 402 and forwards a function call to the input host controller 404 to initialise the user-selected device at the next step 703 for broadcasting input audio and/or visual and/or video data therefrom during the session. At the next step 704, application 402 selects the next data-receiving network-connected device identifier stored in database 403 associated with the device initialised at step 703 according to steps 603 to 607 and forwards a function call to the output host controller 404 to initialise the user-selected device at the next step 705 for receiving out audio and/or video data therefrom during the session. At step 706, application 402 establishes a direct network connection between the data-generating device of step 702, 703 and the data-receiving device of step 704, 705.

A first question is asked at step 707, as to whether another data-receiving network-connected device should be initialised then directly connected to the data-generating network-connected device of steps 702, 703. If the question of step 707 is answered positively, control proceeds to step 704 to perform said initialization and network connection Alternatively, the question of step 707 is answered negatively, whereby a second question is asked at step 708, as to whether another data-generating network-connected device should be initialised then directly connected to one or a plurality of data-receiving network-connected devices. If the question of step 708 is answered positively, control proceeds to step 702 to perform said initialisation and, eventually, network connections. Alternatively, the question of step 708 is answered negatively, whereby initialised data-generating devices input audio and/or visual data to their respective input host controllers, which subsequently forward said input data to output host controller of respective, selected data-receiving devices according to said direct network connections, irrespective of whether these concurrent connections are wired, wireless, area, spectrum or radio-frequency based.

A final question is asked at step 710, as to whether another session identifier is stored in database 403, whereby further initialisations and direct network connections should be processed so as to distribute same or different audio and/or visual data to same or different audience. If the question of step 710 is answered positively, control returns to step 701, whereby application 402 declares the next session to be processed according to the next session identifier stored in database 403 and so on and so forth. Alternatively, if the question of step 710 is answered negatively, whereby control may proceed to question of step 308 and real-time user input defining alternative session parameters may be provided and processed.

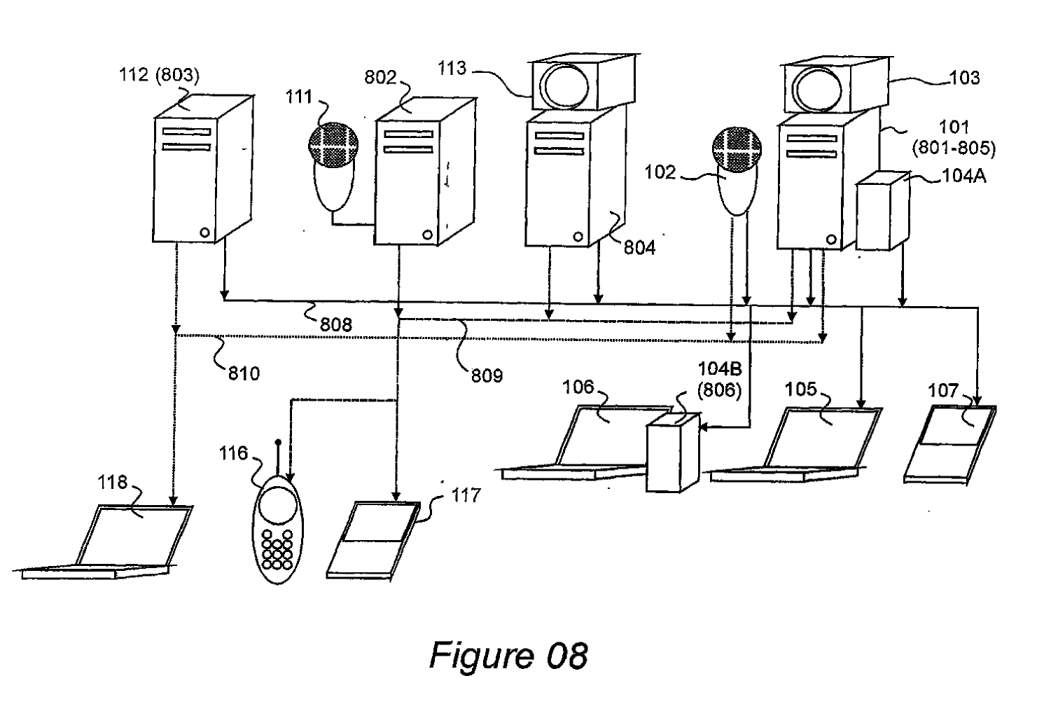

The networked environment of FIG. 1 is shown in FIG. 8, wherein audio-visual data is distributed as data steams from local and remote data-generating devices to local and remote data-receiving devices according to the present invention. Terminal 101 at the presentation venue is configured by instructions 402 to identify terminal-connected data inputting means 102 and wireless visual data broadcasting means 104A as local data-generating devices, of which it is the input host controller 801. Terminal 101 is also configured by instructions 402 to identify remote microphone 111, famestore 112 and webeam 113 as remote data-generating devices, wherein the terminals by means of which they are connected to terminal 101 are configured by API 404 as the respective input host controllers 802, 803 and 804 of said data-generating devices.

Terminal 101 is further configured by instructions 402 to identify local visual data projecting means 103 as a local data-receiving device, local wireless personal portable computers 105, 106 and Bluetooth-connected mobile communication device 107 as further local data-receiving devices. Terminal 101 is the output host controller 805 of mobile devices 105 and 107 and wireless audio-visual data receiving means 104B is the output host controller 806 of device 106. Terminal 101 is yet further configured by instructions 402 to identify remote mobile device 116, mobile device 117 and personal portable computer 118 as remote data-receiving devices, each of these having preferably logged in at said terminal 101 over the Internet 109.

In the example, the presentation includes an advertisement from framestore 112, real-time store footage from webcam 113, slides from a removable data carrying medium read by dice 207 of terminal 101, real-time sales data from the terminal to which webcam 113 is connected being interfaced with store point-of-sale systems (not shown), real-time simultaneous translation from microphone 111 and real-time speech by the user-presenter input by microphone 102. Preferably, the local audience requires presentation of all of the audio-visual data; users of mobile devices 116, 117 require translated speech, slides and sales figures; the user of device 118 is located at the store at which webcam 113 is located and only requires tee advertisement, the speech and the slides. In accordance with the present invention, the user-presenter connects her session controller to terminal 101, which is terminal 101 itself in the preferred embodiment of the present invention, but may be any of a wire- or wirelessly-connected data processing device identified at step 303 in an alternative embodiment.

According to the example, therefore, said user defines a first presentation session 808 with selectively selecting devices 101-206 (slides), 102 (speech), 112 (advertisement video), 113 (real-time store video and sales) as data-generating devices, irrespective of network connection type, path, protocol or host controllers, then selectively selecting devices 103 and 105 to 107 as data-receiving devices of said selected data-generating devices, again irrespective of network connection type, path, protocol or host controllers, according to steps 602 to 608. If the question of step 306 is answered positively to define the “store” presentation, whereby said user defines a second presentation session 809 with selectively selecting devices 101-206 (slides), 102 (speech), and 112 (advertisement video) as data-generating devices, irrespective of network connection type, pat, protocol or host controllers, then selectively selecting device 118 as the data-receiving device of said selected data-generating devices, again irrespective of network connection type, path, protocol or host controllers, according to steps 602 to 608. Finally, the question of step 306 is again answered positively to define the “remote translated” presentation, whereby said user defines a third presentation session 810 with selectively selecting devices 101-206 (slides), 111 (translated speech) and 113 (real-time sales only) as data-generating devices, irrespective of network connection type, path, protocol or host controllers, then selectively selecting devices 116, 117 as the data-receiving devices of said selected data-generating devices, again irrespective of network connection type, path, protocol or host controllers, according to steps 602 to 608.

Upon completing the above session parameter inputting, the three sessions 808, 809 and 810 respectively shown as continuous, long-dashed and short-dashed lines, are concurrently processed by application 402 according to step 307 at terminal 101, with selectively distributing audiovisual data between selectively selected data-generating network-connected devices and selectively selected data-receiving network-connected devices, wherein audio-visual data stunning control is performed by respective API 404 configured input and output host controllers.

It will be appreciated from the present invention that is possible to deploy the server, Media repository, Output Host Controllers and Input Host Controllers depending on the application. Basically the OHCs and IHCs need to be near the targets and sources they are controlling. The server, media repository, and session controllers can be anywhere. In a lectern version embodiment of the present invention, everything runs on a single computer embedded into the lectern. In a campus version in a university or educational facility, everything is distributed, with the server and repository located centrally, the IHCs on computers in the rooms where the equipment they are controlling is located which is connected back to the server over a wired or wireless network. The Session Controllers are running on small devices laptop, PDA, Mobile phone connected back to the server over a wired or, most likely, wireless network). The present invention supports central administration of OHCs IHCs and the devices that they are controlling.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The =Her may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means

The invention is not limited to the embodiments hereinbefore described but may be varied in both construction and detail.

The words “comprises/comprising” and the words “having/including” when used herein with reference to the present invention are used to specify the presence of stated features, integers, steps or components but does not preclude the presence or addition of one or more other features, integers, steps, components or groups thereof.

1. A system for controlling data distribution in a network, said network having at least one data-generating device and at least one data-receiving device, said system comprising memory means, processing means, networking means, at least one input controller and at least one output controller, said memory means storing instructions which configure said processing means to
identify said at least one data-generating device and said at least one data-receiving device in said network;
initialise said identified devices across said network by way of said at least one input controller and said at least one output controller respectively;
control data input by said initialised data generating device by way of said at least one input controller; and
control data output to said initialised data receiving device by way of said at least one output controller, wherein said control is performed selectively according to user input.

2. A system according to claim 1, wherein said network includes a plurality of data-generating devices and at least one data-receiving device, each of said data-generating devices having a respective input host controller and said data-receiving device having an output host controller.

3. A system according to claim 1, wherein said network includes at least one data-generating device and a plurality of data-receiving device, each having a respective host controller, said data-generating device having an input host controller and each of said data-receiving devices having a respective output host controller.

4. A system according to claim 1, wherein said network includes a plurality of data-generating devices and a plurality of data-receiving devices, each of said data-generating devices having a respective input host controller and each of said data-receiving devices having a respective output host controller.

5. A system according to any of claims 1 to 4, wherein said input host controllers and output host controllers control direct network connections between respective data-generating devices and data-receiving devices.

6. A system according to claim 5, wherein said user input defines a data distribution session, comprising one or a plurality of said direct network connections.

7. A system according to claim 6, wherein said user input defines a plurality of data distribution session, comprising one or a plurality of respective direct network connections.

8. A system according to any of claims 1 to 7, wherein said network is a composite network including wired and wirelessly-connected devices.

9. A system according to claim 8, wherein said input data and output data is distributed within said network by way of radio broadcasts.

10. A system according to claim 8, wherein said input data and output data is distributed within said network by way of infra-red transmissions.

11. A method for controlling data distribution in a network having at least one data-generating device and at least one data-receiving device, said method comprising the steps of
identifying said at least one data-generating device and said at least one data-receiving device in said network;
initialising said identified devices across said network by way of said at least one input controller and said at least one output controller respectively;
controlling data input by said initialised data generating device by way of said at least one input controller; and
controlling data output to said initialised data receiving device by way of said at least one output controller, wherein said control is performed selectively according to user input.

12. A method according to claim 11, wherein said network includes a plurality of data-generating devices and at least one data-receiving device, each of said data-generating devices having a respective input host controller and said data-receiving device having an output host controller.

13. A method according to claim 11, wherein said network includes at least one data-generating device and a plurality of data-receiving device, each having a respective host controller, said data-generating device having an input host controller and each of said data-receiving devices having a respective output host controller.

14. A method according to claim 11, wherein said network includes a plurality of data-generating devices and a plurality of data-receiving devices, each of said data-generating devices having a respective input host controller and each of said data-receiving devices having a respective output host controller.

15. A method according to any of claims 11 to 14, wherein said input host controllers and output host controllers control direct network connections between respective data-generating devices and data-receiving devices.

16. A method according to claim 15, wherein said user input defines a data distribution session, comprising one or a plurality of said direct network connections.

17. A method according to claim 16, wherein said user input defines a plurality of data distribution session, comprising one or a plurality of respective direct network connections.

18. A method according to any of claims 11 to 17, wherein said network is a composite network including wired and wirelessly-connected devices.

19. A method according to claim 18, wherein said input data and output data is distributed within said network by way of radio broadcasts.

20. A method according to claim 18, wherein said input data and output data is distributed within said network by way of infra-red transmissions.

21. A computer program comprising program instructions for causing a computer to perform the method of any one of claims 11 to 20.

22. A computer program as claimed in claim 21 embodied on a record medium

23. A computer program as claimed in claim 21 embodied on a carrier signal.

24. A computer program as claimed in claim 21 embodied on a read-only memory.

25. A data carrying medium containing a set of instructions for controlling data distribution in a network having at least one data-generating device and at least one data-receiving device, whereby when loaded into a data processing system configured with data carrying reading means, said instructions configure a processor to identify said at least one data-generating device and said at least one data-receiving device in said network;
initialise said identified devices across said network by way of said at least one input controller and said at least one output controller respectively;
control data input by said initialised data generating device by way of said at least one input controller; and
control data output to said initialised data receiving device by way of said at least one output controller, wherein said control is performed selectively according to user input.
